(19) United States
(12) Patent Application Publication
(10) Pub. No.: US 2026/0004945 A1
(43) Pub. Date: Jan. 1, 2026

(54) COMPACT ISOTOPE TARGET STATION WITH AUTO LOAD AND RETRIEVAL

(71) Applicant: University of Washington, Seattle, WA (US)

(72) Inventors: Robert EMERY, Seattle, WA (US); Greg MOFFITT, Seattle, WA (US); Eric DORMAN, Seattle, WA (US); Marissa KRANZ, Seattle, WA (US); Robert SMITH, Seattle, WA (US)

(73) Assignee: University of Washington, Seattle, WA (US)

(21) Appl. No.: 18/868,362

(22) PCT Filed: May 19, 2023
(86) PCT No.: PCT/US2023/022830

§ 371 Date: Nov. 22, 2024

Related U.S. Application Data
(60) Provisional application No. 63/344,964, filed on May 23, 2022.

(51) Int. Cl. G21K 5/08; G21G 1/00

(52) U.S. Cl. CPC G21K 5/08; G21G 1/0005; G21G 1/001

(57) ABSTRACT

A radioisotope target station, including a target housing. The target housing includes a target material, and a target backing material. The radioisotope target station includes a loader mechanism comprising at least one jaw configured to secure the target housing, a loading position comprising a magazine, wherein the magazine is configured to hold two or more target housings, an irradiation position comprising a beam, where the beam is configured to irradiate the target housing orthogonally, a cooling fluid source fluidly coupled to the loader mechanism, where the cooling fluid source is configured to cool the target housing as the target housing is irradiated, and an ejection position comprising an ejector and an ejection chute, where the ejector is configured to detach the target housing from the loader mechanism and the ejection chute is configured to receive the target housing when detached.

### CROSS-REFERENCE TO RELATED APPLICATION

This application claims the benefit of U.S. Provisional No. 63/344,964, filed May 23, 2022, the entire disclosure of which is hereby incorporated by reference.

### STATEMENT OF GOVERNMENT LICENSE RIGHTS

This invention was made with government support under Grant No. DE-SC0019197, awarded by the U.S. Department of Energy. The government has certain rights in the invention.

### BACKGROUND

Radioisotope target stations are used to produce radioisotopes, such as ²¹¹At (known as Astatine-211). However, conventional target stations may not be able to use multiple forms of target material and may require large amounts of personal exposure over long amounts of time. Further, conventional target stations may not produce as many radioisotopes as desired, lack the ability for a target to be loaded remotely, and may not include components capable of safely containing used targets.

Accordingly, radioisotope target stations and methods for using radioisotope target stations are needed.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, disclosed herein is a radioisotope target station, including a target housing including a target material, and a target backing material. In some embodiments, the radioisotope target station further includes a loader mechanism including at least one jaw configured to secure the target housing, a loading position comprising a magazine, where the magazine is configured to hold two or more targets housings, an irradiation position comprising a beam, where the beam is configured to irradiate the target housing orthogonally, a cooling fluid source fluidly coupled to the loader mechanism, where the cooling fluid source is configured to cool the target housing as the target housing is irradiated, and an ejection position comprising an ejector and an ejection chute, where the ejector is configured to detach the target housing from the loader mechanism and the ejection chute is configured to receive the target housing when detached, where the loader mechanism is configured to move between the loading position, the irradiation position, and the ejection position.

In other aspect, disclosed herein is a method of producing an isotope with the radioisotope target station, the method including moving the loader mechanism to the loading position, securing the target housing with the one or more jaws on the loader mechanism, where the target comprises the target backing material and the target material, moving the loader mechanism to the irradiation position, sealing the target housing to the beamline endplate, irradiating the target housing with the beam to produce an isotope, wherein the beam is orthogonal to the target housing, cooling the target housing with the cooling fluid source fluidly coupled to the loader mechanism while the target housing is irradiated, removing the target housing from the beamline endplate, moving the loader mechanism to the ejection position, and detaching the target housing from the loader mechanism and into the ejection chute.

In yet another aspect, disclosed herein is a target housing including a first face including a well configured to hold a target backing material and a target material orthogonally to a beam, and a groove configured to vacuum seal the first face to a beamline endplate. In some embodiments, the target housing includes a second face, opposite the first face, including a water recess configured to fluidly couple with a cooling fluid source, and a thickness between the first and second face, where the thickness ranges from 6-20 mm thick.

In yet another aspect, disclosed herein is a device for manufacturing a target housing, including a base including a recess, a ball bearing configured to rest in the recess, and a platform configured to rest on top of the ball bearing. In some embodiments, the platform includes a top face, including a stepped surface at the center of the platform configured to hold a target housing, at least one clamp configured to form a groove on the target housing, at least one screw located midway between an edge and the center of the platform and configured to coarsely adjust the target housing, at least one setscrew configured to flex the platform to finely adjust the target housing, and a bottom face, including a cylindrical recess configured to contain a portion of the ball bearing, and an inner portion and an outer portion, delineated by a recessed circular groove, where the recessed circular groove is configured to flex the inner portion separately from the outer portion.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a top left side perspective view of an example radioisotope target station, in accordance with the present technology;

FIG. 2 is a top back perspective view of the radioisotope target station of FIG. 1, in accordance with the present technology;

FIG. 3 is a top right-side perspective view of the radioisotope target station of FIG. 1, in accordance with the present technology;

FIG. 4 is a portion of the radioisotope target station of FIG. 1, in accordance with the present technology;

FIG. 5A is an example target housing, in accordance with the present technology;

FIG. 5B is a front of an example cooling cup without a target housing installed, in accordance with the present technology;

FIG. 5C is a front of an example cooling cup with a target housing installed, in accordance with the present technology;

FIG. 5D is an exploded perspective of an example cooling cup with a target housing installed, in accordance with the present technology;

FIG. 6A is a top perspective of an example target housing, in accordance with the present technology;

FIG. 6B is a bottom perspective of the target housing of FIG. 6A, in accordance with the present technology;

FIG. 6C is a cross-section of an example target housing, in accordance with the present technology;

FIG. 6D is a top perspective of another example target housing, in accordance with the present technology;

FIG. 6E is a bottom perspective of the target housing of FIG. 6D, in accordance with the present technology;

FIG. 6F is another example target housing including a backing material and a target material, in accordance with the present technology;

FIGS. 7A-7F are process diagrams of the radioisotope target station of FIG. 1 in use, in accordance with the present technology;

FIG. 8A is a top perspective view of an example device for manufacturing a target housing, in accordance with the present technology;

FIG. 8B is a bottom perspective view of the device for manufacturing a target housing of FIG. 8A, in accordance with the present technology;

FIG. 9 is an example method of using a radioisotope target station, in accordance with the present technology; and

FIG. 10 is an example method of using a device for manufacturing a target housing, in accordance with the present technology.

### DETAILED DESCRIPTION

While illustrative embodiments have been illustrated and described, it will be appreciated that various changes can be made therein without departing from the spirit and scope of the invention.

The radioisotope target station discloses herein is a pneumatically operated target irradiation station meant for external beam particle accelerators in oncology treatment and research environments. In some embodiments, the purpose of this radioisotope target station is the production of an a-emitting radionuclide, ²¹¹At (known as Astatine-211). In some embodiments, a target of the radioisotope station is specifically designed for this purpose, in conjunction with the target station. In some embodiments, the radioisotope target station can also be used for radiotherapy research with assorted radioisotopes such as, but not limited to, RbCl (Rubidium Chloride), ²³²Th (Thorium-232), Sr⁸⁵ (Stronium-85), Sn^{117m} (Tin-177m), Tb¹⁵⁵ (Terbium-155), Re¹⁸⁶ (Rhenium-186), Re¹⁸⁹ (Rhenium-189), At²¹¹ (Astitine-211), U²³⁰ (Uranium-230), Pa²³⁰ (Protactinium-230), Np²³⁶ (Neptunium-236), Ge⁶⁸ (Germanium-68), In¹¹¹ (Indium-111), I¹²³ (Iodine-123), I¹²⁴ (Iodine-124), and Lu¹⁷⁷ (Lutetium-177) due to the fact that the target station can accept targets with target material in various forms including, but not limited to, foils, powders, crystals, melted material, plated materials, sputtered materials, solids, liquids, and gasses, accommodating up to a target material thickness of 20 mm.

The radioisotope target station disclosed herein has many benefits. In some embodiments, using the radioisotope target station disclosed herein reduces personal exposure levels to radioactive products. Similarly, it can also reduce exposure time with radioactive products. In some embodiments, the radioisotope target station produces large quantities of Astatine-211 for the novel treatment of cancer patients. In some embodiments, the radioisotope target station is configured to allow a target to be remotely loaded, irradiated, and retrieved. In some embodiments, the radioisotope target station is configured to allow numerous targets and a variety of targets to sequentially be used with the same radioisotope target station, with remote individual identification for each target.

In some embodiments, the radioisotope target station allows for reduction of target material, simplifying target processing and reducing target and processing costs. In addition, the radioisotope target station is configured to provide safe containment of final irradiated targets into shielded transport or storage pigs, lead transport carts, or turntable vacuum transfer systems to a hot cell processing chamber.

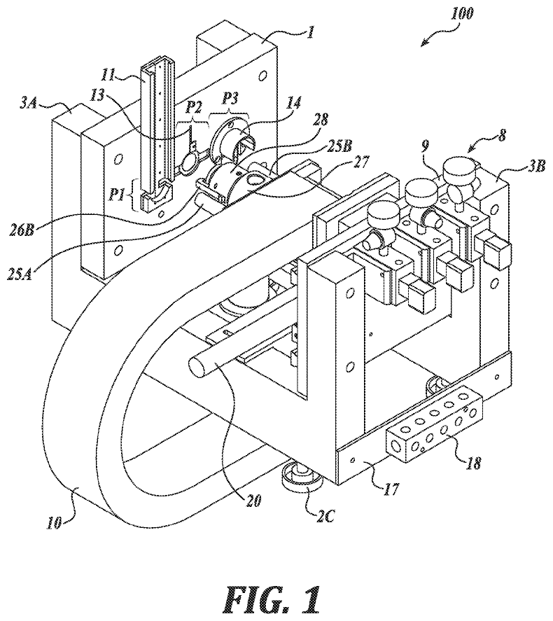

Turning now to the figures, FIG. 1 is a top left side perspective view of an example radioisotope target station 100, in accordance with the present technology. In some embodiments, the radioisotope target station 100 includes a beamline endplate 1, one or more feet 2, one or more C-frame channels 3A, 3B, one or more pressure regulators with gauges 8, a loader baseplate 9, a wire/tubing guide 10, and a magazine 11. In some embodiments, the radioisotope target station 100 further includes a target irradiate proximity sensor 13, an ejector 14, a manifold bracket 17, a manifold 18, a positioning air cylinder 20, one or more guide rods 25A, 25B, one or more jaws 26A, 26B, and a ram cup assembly 27 (also referred to as a cooling cup assembly herein). In some embodiments, the radioisotope target station 100 further includes a loading position P1, an irradiation position P2, and an ejection position P3.

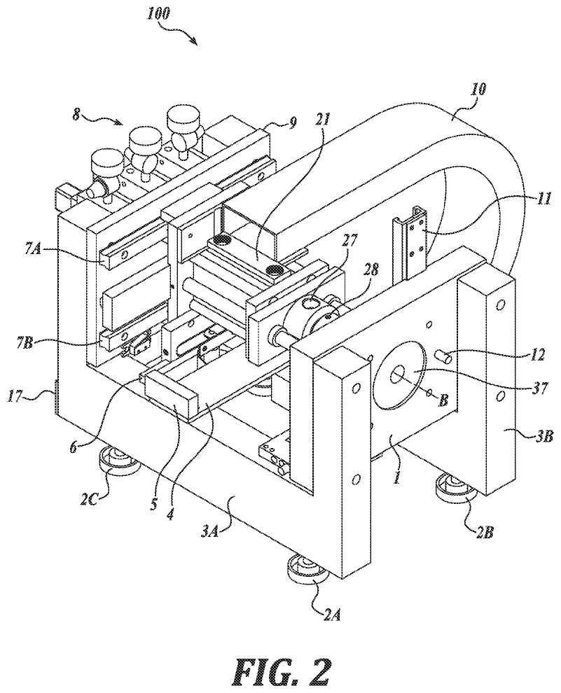

FIG. 2 is a top back perspective view of the radioisotope target station 100 of FIG. 1, in accordance with the present technology. In some embodiments, the radioisotope target station 100 includes a beamline endplate 1, one or more feet 2A, 2B, 2C, one or more C frame channels 3A, 3B, a gate arm crossbar 4, a gate arm pivot 5, a horizontal gate arm 6, linear bearing rails 7A, 7B, at least one pressure regulator 8, a loader baseplate 9, a wire/tubing guide 10, at least one magazine 11, and a magazine proximity sensor 12.

The radioisotope target station 100 may be constructed of two large steel “C” frame channels 3A, 3B with a beamline endplate 1 connected to one end of the C frame channels 3A, 3B and a loader baseplate 9 connected to the opposite side. This assures a very open design to allow for easy operation, modifications, service, and inspections. In some embodiments, both the beamline endplate 1 and the loader baseplate 9 are made of aluminum.

The two C channels 3A, 3B may be tungsten inert gas (TIG) welded together to form a very rigid frame with low flexure to maintain alignment. The beamline endplate 1 allows many possible variations for a large range of research possibilities. In some embodiments, the beamline endplate 1 is connected to an accelerator beamline, or beam (not illustrated in FIG. 1) via a Iso63-K vacuum fitting. In some embodiments, the loader baseplate 9 is adjustable to achieve parallelism between the loader baseplate 9 and the beamline endplate 1. In some embodiments, there are four feet 2A, 2B, 2C under the C channels 3A, 3B that are threaded for height adjustment and have electrical isolation from the steel shelf upon which it sits. While only three feet 2A, 2B, 2C are illustrated in FIG. 2, it should be understood this is due to perspective, and a fourth foot may be located on the fourth corner of the radioisotope target station 100.

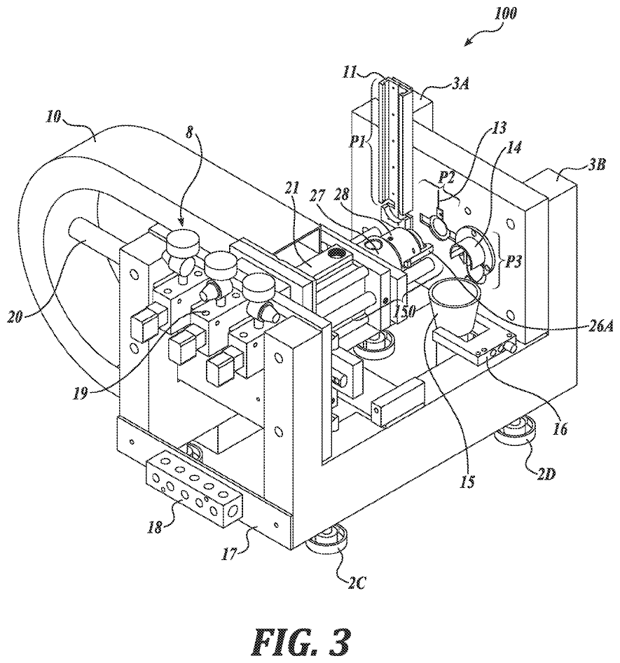

FIG. 3 is a top right-side perspective view of the radioisotope target station 100 of FIG. 1, in accordance with the present technology. In some embodiments, the radioisotope target station 100 further includes a target irradiate proximity sensor 13, an ejector 14, an ejection chute 15, an ejection infrared (IR) sensor 16, a manifold bracket 17, a manifold 18, air valves and coils 19, a positioning air cylinder 20, and a ram air cylinder 21. In some embodiments, the ram air cylinder 21 includes two air cylinders. In some embodiments, there may be any number of positioning air cylinders 20. In some embodiments, the radioisotope target station 100 further includes a loader mechanism 150, which includes a ram/cooling cup 27, one or more jaws 26B, one or more ram air cylinders 21, and a sliding seal 28.

The radioisotope target station 100 may include one or more air cylinders 20, 21 to move the mechanisms. In some embodiments, the largest diameter cylinder, such as the ram air cylinder 21 of the one or more air cylinders applies pressure to the back of the target to both compress an O-ring of the sliding seal 28 to the beamline endplate 1 and to seal cooling water behind the target to the ram/cooling cup 27. Two smaller diameter air cylinders (or positioning cylinders) 20 apply pressure to move the ram/cooling cup 27 into 3 distinct positions to allow full processing. In some embodiments, the longer air cylinder of the of the one or more positioning cylinders 20 moves the ram/cooling cup 27 laterally while the smaller air cylinder of the positioning cylinders 21 controls the ram/cooling cup's 27 positions P1, P2, P3 via a dual path gated mechanism (the gate arm crossbar 4, the gate arm pivot 5, and the horizontal gate arm 6). Each stop position can be adjusted independently. In some embodiments, there are three specific positions: Load P1, Irradiate P2, and Eject P3.

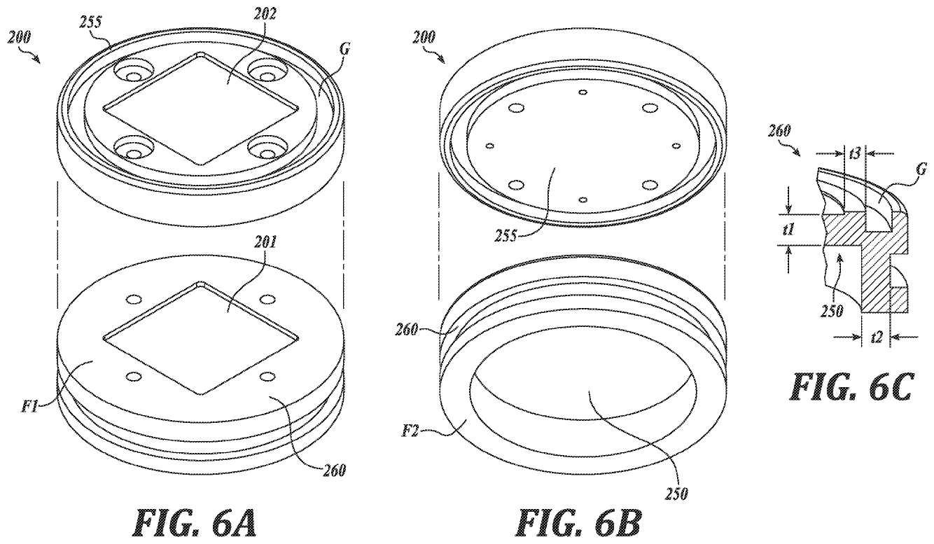

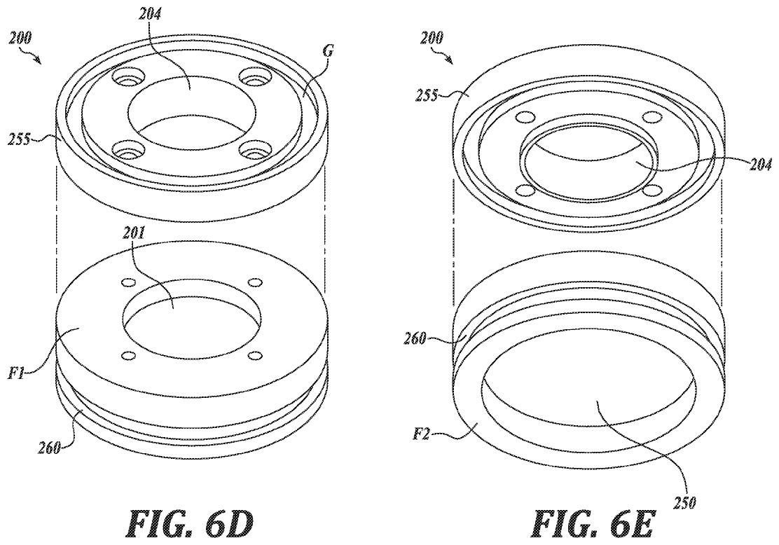

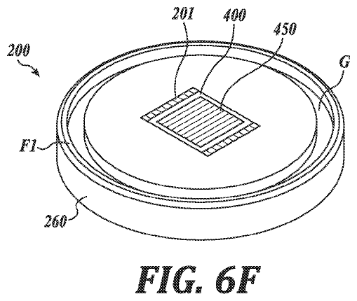

In some embodiments, each position (loading P1, irradiation P2, and ejection P3) includes one or more components of the radioisotope target station 100. For example, the loading position P1 comprises the magazine 11. In some embodiments, the magazine 11 is configured to hold one or more targets (as shown in FIGS. 6A-6D). In some embodiments, the irradiation position P2 includes the beamline endplate 1. In some embodiments, the irradiation position P2 further includes a beam, such as beam B in FIG. 2. In some embodiments, the ejection position P3 includes the ejector 14 and the ejection chute 15. In some embodiments, one or more air cylinders (such as ram air cylinder 21 and positioning air cylinder 20) move the loader mechanism 150 to each of these positions P1, P2, P3.

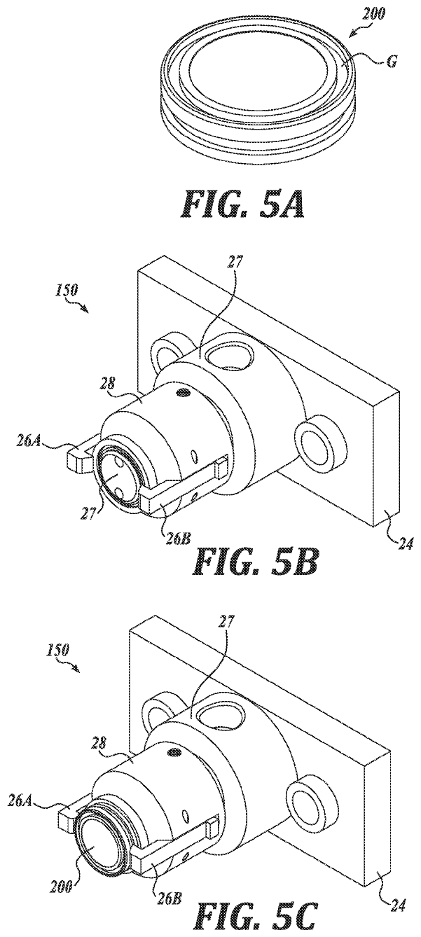

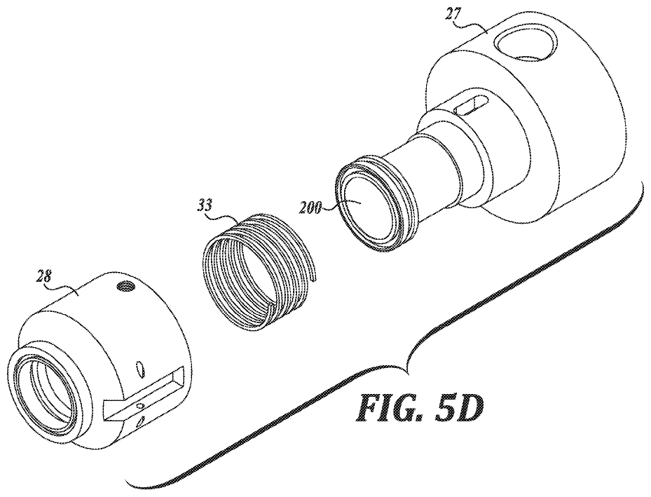

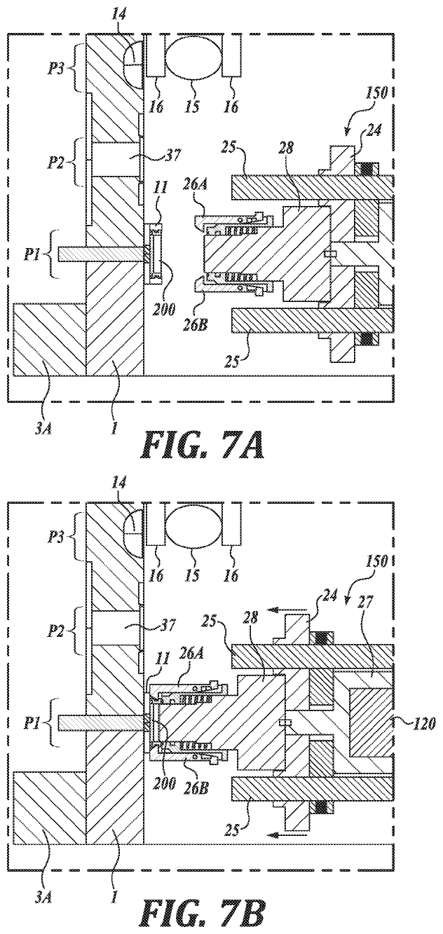

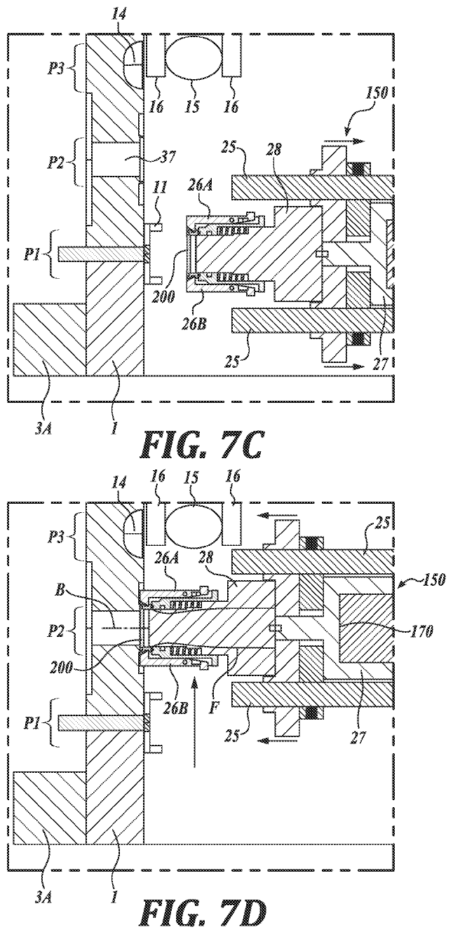

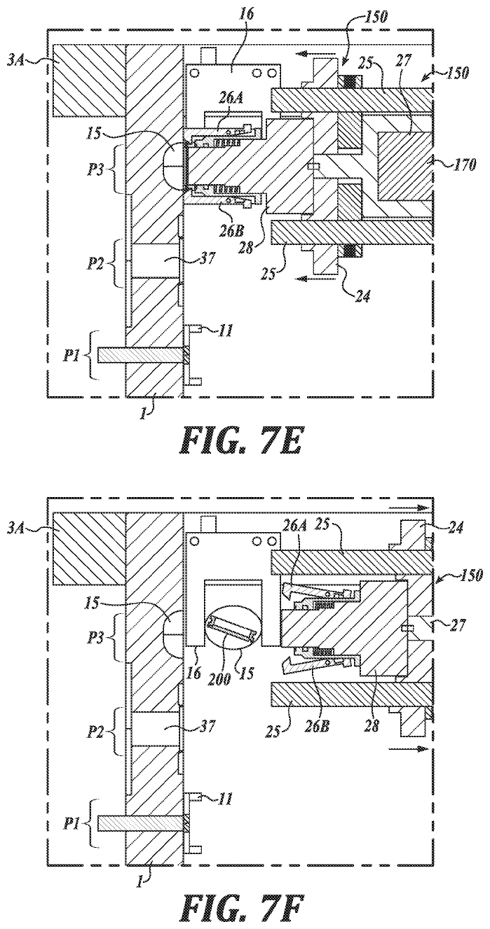

In some embodiments, disclosed herein is a radioisotope target station 100, including a target (as shown in FIGS. 5A-5D) comprising a target housing, a target material, and a target backing material, a loader mechanism 150 comprising at least one jaw 26A, 26B configured to secure the target, a loading position P1 comprising a magazine 11, where the magazine 11 is configured to hold two or more targets, an irradiation position P2 comprising a beam B, wherein the beam B is configured to irradiate the target orthogonally, a cooling fluid source (as shown in FIGS. 7A-7F) fluidly coupled to the loader mechanism 150, where the cooling fluid source is configured to cool the target as the target is irradiated, and an ejection position P3 comprising an ejector 14 and an ejection chute 15, where the ejector 14 is configured to detach the target from the loader mechanism 150 and the ejection chute 15 is configured to receive the target when detached, where the loader mechanism 150 is configured to move between the loading position P1, the irradiation position P2, and the ejection position P3.

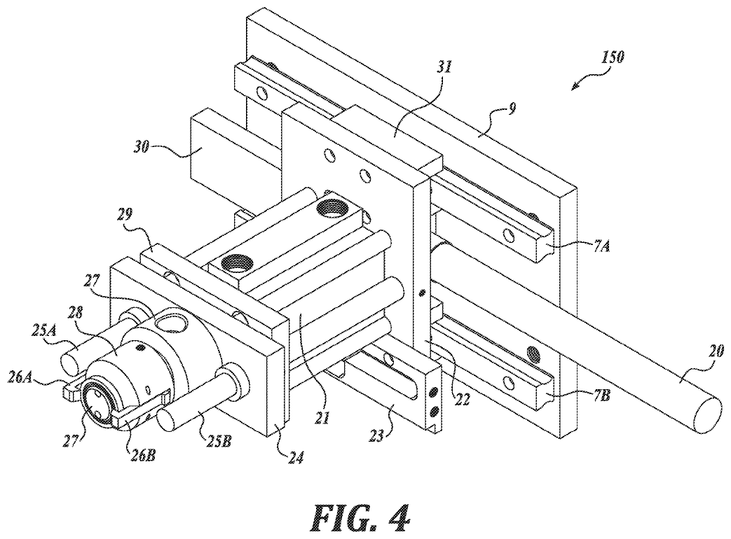

FIG. 4 is a portion of the radioisotope target station 100 of FIG. 1, in accordance with the present technology. In some embodiments, the radioisotope target station 100 includes a loader mechanism 150. In some embodiments, the loader mechanism 150 includes a positioning air cylinder 20, a ram air cylinder 21, a shuttle plate 22, a gate plate 23, a ram plate adapter 24, one or more guide rods 25A, 25B, one or more jaws 26A, 26B, a ram/cooling cup assembly 27, a sliding seal 28, a cylinder front plate 29, a shuttle extension plate 30, and one or more carriages 31.

In some embodiments, the ram/cooling cup 27 moves laterally via two linear ball bearing carriages 31 and two accompanying rails 7A, 7B. The ball bearing movement of the carriage 31 maintains proper position repeatability with precision. The long positioning air cylinder 20 is placed in a compact position between the two rails 7A, 7B. The gate plate 23 that controls lateral stopping position has a ball bearing guide that rides in one of two slots, connected by a vertical channel. This channel allows switching from a stop position when it is coming from one direction, then allows full travel return when coming the opposite direction (i.e., without stopping). The gate is a separate plate 23 attached to the main shuttle plate 22 so if different positioning needs arise, the gate plate 23 may be swapped. In some embodiments, the ball bearing guide is rigidly tied to the frame via a horizontal gate arm 6 which absorbs the forces of stopping at each position.

In some embodiments, the carriages 31 are attached to a shuttle plate 22, which holds the large diameter ram air cylinder 21, ram assembly 27, guide rods 25A, 25B, and ram plate adapter 24. This allows all components to move laterally as an assembly while carrying wiring and hoses to avoid damage. The lateral movement is protected by the cable/hose carrier while the longitudinal target housing movement does not need this type of protection.

In some embodiments, the magazine 11 can hold up to six target housings, but it should be appreciated that any number of target housings could be held by the magazine 11. This allows the user to load the magazine 11 remotely to reduce radiation exposure, carry it to the loader, then slide it into position via a dovetail. Each magazine 11 may be sized to a specific thickness of the target housing. In some embodiments, the magazine 11 is aluminum. The dovetail is reversible if any wear is detected. As one target housing is grabbed, then retracted back, the next target housing in queue is gravity fed into position. In some embodiments, the magazine 11 can be fed by multiple high-capacity storage devices, each storing a different type of target housing. These different types of target housings 200 may be remotely identified with markings such that the accelerator operator can ensure the correct target housing type is loaded.

The ejector 14 may be a flanged half tube extension attached it the beamline endplate 1. In some embodiments, the ejector 14 serves two purposes while ejecting a target housing 200 from the ram/cooling cup 27. First is that the ejector 14 spreads the one or more jaws 26A, 26B to unlock the target housing 200 and allow it to fall. Second, is that some target housings may be hard to eject due to vacuum grease or heating of the O-ring of the sliding seal 28. The ejector 14 contains the target housing if a burst of compressed air through the cooling fluid line is used to aid in ejection. There is also a rounded slot placed in the beamline endplate 1 that allows the target housing to tumble into a tapered tube chute (ejection chute 15), then proceed to fall downward. The end of this tube may include a KF-40 vacuum fitting that allows other tubes to be quickly attached to it for configuring different ejection modes. This allows modification of the system with a standard tube size in any number of laboratory settings.

There may be three different modes of target housing capture once it has fallen down the ejection chute 15. One of the first modes to be setup will be to capture the target housing in a lead shipping pig. The pig is placed in an 80/20 framed pull-out drawer. The drawer has 80/20 slide bearings that allow smooth movement and registered stops. The stops center the pig directly below the ejection chute. Since the pig sits directly under the chute, there is no need for any additional tubing or hinge clamps. The second mode of ejection requires a tube extension and hinge clamp. This extends the chute lower, allowing the target housing to fall directly into a lead transport cart. The cart is put into place via angle aluminum that tapers to “park” the cart directly under the extension. The doors of the cart are opened first, then the cart is slid into place. After irradiation and ejection, the cart is moved out and closed shut. If the target housing has a large amount of residual radioactivity present, the cart can be wheeled into a corner of the cyclotron room to allow it to decay to a safer level before transport or post-processing.

The third method of ejection is directly into a turntable vacuum transport system. This vacuum system then transports the targets to a hot cell processing chamber in a separate room outside of the cyclotron vault. This allows fully irradiated target housings to be processed soon after irradiation making possible shorter half-life viability usage and possible farther shipping distances. In some embodiments, a gated chute system, like the switching gates used by railroad locomotives and cars to move to different tracks, may be utilized. This allows remote changes to the chute system via a programmable logic controller or some such other computing device with input/output capabilities.

The radioisotope target station 100 may utilize assorted sensors to affirm target locations before proceeding with a particular operation. An inductive proximity sensor (or magazine proximity sensor) 12 may sense a target housing as it falls into the loading position P1, verifying that there is a target housing to be captured by one or more jaws 26A, 26B. A second inductive proximity sensor (or as irradiate proximity sensor) 13 may sense that a target is loaded to the irradiation position P2 before valving opens to introduce vacuum to the front of the target. An (infrared) IR optical sensor (or ejection IR sensor) 16 may be placed on the ejection chute 15 to verify that the target housing has fallen from the first face of the ram/cooling cup 27 while at the ejection position P3. The main ram cylinder 21 and positioning cylinder 20 may utilize reed position switches to indicate when extended or retracted. A series of three microswitches may be utilized under the linear bearing rails to verify that the loading mechanism 150 has arrived at each of the three positions, loading P1, irradiation P2, and ejection P3. In some embodiments, pressure switches attached to cooling water lines and air lines assure that a minimum of pressure exists to properly perform the radioisotope target station's 100 functions.

In some embodiments, the radioisotope target station 100 is controlled via a PLC (programmable logic controller). In some embodiments, a wired remote controller may be used to control functions while at the radioisotope target station 100. In some embodiments, the remote controller includes a connector attaching it to the PLC.

FIG. 5A is an example target housing 200, in accordance with the present technology. In some embodiments, the target housing 200 is made of bismuth, and is used to create ²¹¹At.

In some embodiments, the target housing 200 is irradiated orthogonally (at 90° angle) to a beam (such as beam B) with full beam utilization. In some embodiments, the target housing 200 may include another target material, such as tungsten, tungsten disulfide, rubidium chloride, cadmium, thorium, germanium, uranium, europium oxide, gadolinium oxide, silver, zinc, Ytterbium, osmium, cobalt, nickel, and antimony. In some embodiments, the target housing 200 includes a high precision thickness target backing material that reduces radioactive waste yet does not interfere with chemical target processing. In the case of the Bismuth target to produce ²¹¹At, the backing material is a precision layer of gold plated onto a thin layer of a tungsten-titanium alloy which in turn is sputtered onto aluminum target housing 200. In some embodiments, the backing material is a thin layer selected from copper, silver, gold, platinum, graphite, graphene, or a combination thereof.

In some embodiments, the target material is selected from bismuth, tungsten, tungsten disulfide, rubidium chloride, cadmium, thorium, germanium, uranium, europium oxide, gadolinium oxide, silver, zinc, Ytterbium, osmium, cobalt, nickel, and antimony. In some embodiments, the target housing 200 is selected from aluminum, copper, gold, silver, platinum, and a combination thereof. In some embodiments, the target backing material further includes a thin layer selected from copper, silver, gold, platinum, graphite, graphene, and a combination thereof.

FIG. 5B is a front of an example cooling cup 27 without a target housing 200 installed, in accordance with the present technology. As shown in the illustrated embodiments of FIG. 5B, the radioisotope target station includes the cooling cup 27, one or more jaws 26A, 26B, a sliding seal 28, and a ram plate adapter 24.

FIG. 5C is a front of an example cooling cup 27 with a target housing 200 installed, in accordance with the present technology. In some embodiments, the cooling cup 27 is configured to hold a target orthogonally. The beam may be 18 mm in diameter. In some embodiments, the beam utilizes an acute angle, for example those advertised as 10° angled units (80° from the beam incidence). The target housing 200 can be irradiated orthogonally using high precision thin barrier targets that have as little as 0.090 mm of target material wherein only the beam energy useful for creating the desired isotope, for example ²¹¹At, is deposited into the target material, which can be poor a poor thermal conductor as with Bismuth. The remainder of the beam, may be deposited in a good thermal conductor, thus allowing for greater beam currents do be delivered without melting the target material and therefore producing the desired isotope at a greater rate. This also allows maximum thermal conductivity via the shortest distance path and an efficient removal of heat flux from the irradiated material layer.

FIG. 5D is an exploded perspective of an example cooling cup 27 with a target housing 200 installed, in accordance with the present technology. In some embodiments, the cooling cup 27 includes a sliding seal 28, and a spring 33. In some embodiments, the ram/cooling cup 27 (also referred to as a target housing) has a sliding seal (or sliding seal assembly) 28 with two O-ring seals for water pressure. This sliding seal 28 allows the use of variable thickness targets 200, with up to 4 mm range of depths. In some embodiments, the thickness between the cooling water and target material range from 0.75 mm (0.030″) to 4.75 mm (0.187″). This can accommodate different cooling characteristics of various materials. The sliding seal 28 uses a spring 33. In some embodiments, the spring 33 is a stacked wave spring assembly to push against the back of the target housing 200 outer lip.

FIG. 6A is a top perspective of an example target housing 200, in accordance with the present technology, and FIG. 6B is a bottom perspective of the target housing 200 of FIG. 6A, in accordance with the present technology. In some embodiments, the target housing 200 includes a top portion 255 and a bottom portion 250, but in other embodiments, the target housing 200 includes only a bottom portion 250.

In some embodiments, the target housing 200 is a foil target, that is, it is configured to accept a foil target material. In some embodiments, the target housing 200 is a two-piece Thorium-232 foil target. In some embodiments, the target housing 200 includes a well 201 and an entrance window 202. In some embodiments, the well 201, is configured to hold a target material. In some embodiments, the entrance window 202 is configured to secure the target material. In some embodiments, the entrance window 202 may be transparent. In other embodiments, the entrance window 202 is opaque or translucent. In some embodiments, the entrance window 202 is selected from graphite, graphene, silicon, aluminum, gold, and silver, or combinations thereof. In some embodiments, the target housing 200 includes a groove G on the front side F1 of the target (as shown in FIG. 6F). However, when the target housing 200 includes top portion 255, the groove G may be located on the top portion 255. In some embodiments, the groove is configured to vacuum seal to a beamline endplate, such as shown in FIGS. 7A-7F. In some embodiments, the target housing 200 includes a water recess 250 on the second face F2 of the target housing 200. In some embodiments, the water recess 250 allows for cooling water to flow behind the target housing 200, as shown in FIG. 7D.

FIG. 6C is a cross-section of an example target housing 200, in accordance with the present technology. In some embodiments, the target housing 200 includes a first thickness t1, a second thickness t2, and a third thickness t3. In some embodiments, the first thickness t1 separates the recess 250 from the first recessed area 201 of the target housing 200. In some embodiments, the first thickness t1 is from 6-8 mm.

In some embodiments, disclosed herein is a target housing 200 including a first face F1 and a second face F2. In some embodiments, the first face F1 includes a well 201 configured to hold a target backing material and a target material (as shown in FIG. 6F) orthogonally to a beam (such as beam B of FIG. 2), and a groove G configured to vacuum seal the first face to a beamline endplate (such as beamline endplate 1). In some embodiments, the second face F2 of the target housing 200 includes a water recess 250 configured to fluidly couple with a water source. In some embodiments, the target housing 200 includes a thickness t1 between the first face F1 and second face F2, wherein the thickness t1 ranges from 6-20 mm thick.

FIG. 6D is a top perspective of another example target housing 200, in accordance with the present technology, and FIG. 6E is a bottom perspective of the target housing 200 of FIG. 6D, in accordance with the present technology. In some embodiments, the target housing 200 is a powder target housing 200, that is configured to hold a target material that is in a powder form. In some embodiments, the target housing 200 includes a well 201 and an opening 204. In some embodiments, the well 201 is configured to hold the target material and the opening 204 is configured to expose the target material. In some embodiments, the top portion 255 is graphite, graphene, silicone, gold, or platinum. In some embodiments, the top portion 255 is configured to connect to the first face F1 of the bottom portion 260. In some embodiments, the entire target housing 200 is aluminum, copper, gold, silver, platinum, or a combination thereof.

FIG. 6F is another example target housing 200 including a backing material 400 and a target material 450, in accordance with the present technology. In some embodiments, the target housing is just bottom portion 260, though it should be understood a top portion (such as top portion 255 of FIGS. 6A-6B, or 6D-6E) may also be included in target housing 200. In some embodiments, the backing material 400 rests in the well 201. In some embodiments, the target material 450 is disposed on top of the backing material 400. In some embodiments, a top portion (such as top portion 255 of FIGS. 6A-6B, or 6D-6E) may be placed onto the bottom portion 260 to cover or expose the target material 450, the backing material 400, or both. While the backing material 400 is illustrated as larger than the target material 450, in some embodiments, the backing material 400 may take up less area, i.e., be completely covered by the target material 450. In some embodiments, the target material 450 and the backing material 400 cover the same amount of area of the well 201 or the bottom portion 260.

In some embodiments, the target material 450 is selected from bismuth, tungsten, tungsten disulfide, rubidium chloride, cadmium, thorium, germanium, uranium, europium oxide, gadolinium oxide, silver, zinc, Ytterbium, osmium, cobalt, nickel, antimony, and combinations thereof. In some embodiments, the target material 450 is selected from powder, a foil, one or more crystals, melted material, plated material, sputtered material, a solid, a liquid, and a gas.

In some embodiments, the target backing material 400 is selected from copper, silver, gold, platinum, graphite, graphene, or a combination thereof. In some embodiments, the target backing material 400 is a thin layer.

In some embodiments, the target housing 200 further includes a groove G on the first face F1 of the target housing 200. In some embodiments, the groove G allows for the target to couple to a beamline endplate (such as beamline endplate 1) and seal during irradiation.

In some embodiments, the target housing 200 may be made of two grades of aluminum. One grade is 6061-T6, an inexpensive grade. The other is 5-N, an abbreviation for Five Nines i.e., 99.999% pure. Though much more expensive, it may be used to minimize radioactive by-products with less than desirable characteristics. The 6 mm thick target station may have a very shallow well 201 at only 0.15 mm. This allows for assorted layers to be stratified onto the front of the target housing 201 (such as a target backing material 400 and/or a target material 450). This may be thinner than that of conventional target housings. Two-piece target housing 200 (such as shown in FIGS. 6A-6B and 6D-6F) of assorted thicknesses may be utilized for various foils, compacted powders, or other layered materials.

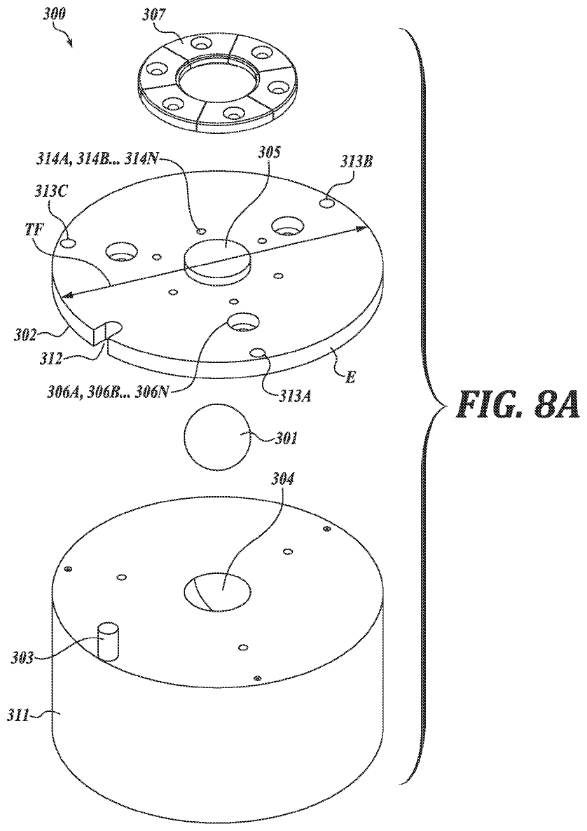

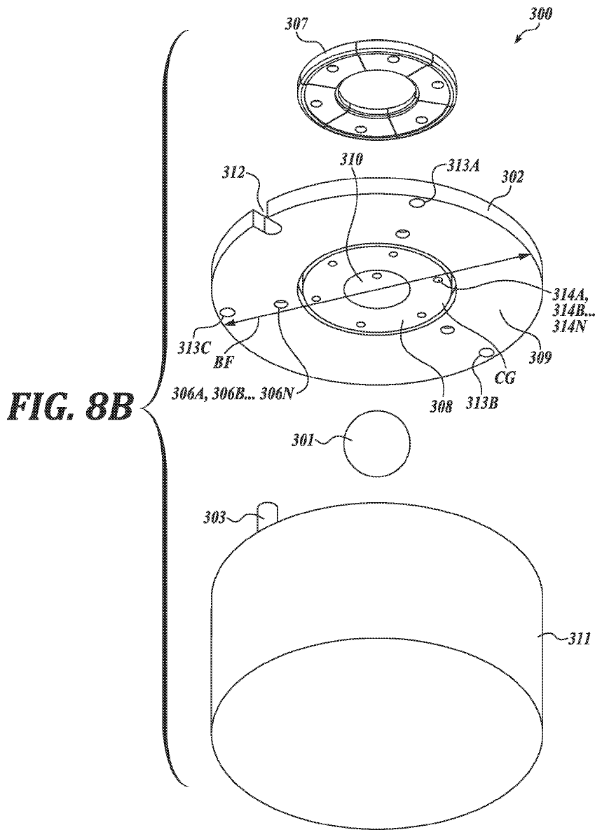

In one example, the target housing 200 is a 6 mm target housing made with high precision dimensional tolerancing. The first face F1, where the target backing material 400 and/or the target material 450 is deposited is under 5 mm and parallel with the rear sealing surface (second face F2). Both the first face F1 and the second face F2 may be glass burnished to achieve very flat surfaces. In some embodiments, the first face F1 and the second face F2 are flat enough so that when machining the front face F1 of the target housing 200 there may be tolerances of approximately 5 microns. In some embodiments, the target housing 200 is machined with a device for manufacturing a target housing, as shown and described in FIGS. 8A-8B.

FIGS. 7A-7F are process diagrams of the radioisotope target station 100 of FIG. 1 in use, in accordance with the present technology. It should be understood that FIGS. 7A-7F are top-down perspectives of the radioisotope target station 100. In some embodiments, the radioisotope target station 100 includes a beamline endplate 1 connected to one or more C frame channels 3. In some embodiments, the beamline endplate 1 includes three positions, a loading position P1 including a magazine 11, an irradiation position P2 including a beam B, and an ejection position P3 including an ejector 14 and an ejection chute 15. In some embodiments, the ejection position P3 may further include an ejector IR sensor 16. In some embodiments, the radioisotope target station 100 further includes a loader mechanism 150, configured to move between the loading position P1, the irradiation position P2, and the ejection position P3. In some embodiments, the loader mechanism 150 includes a ram/cooling cup assembly 27, a sliding seal 28, and one or more jaws 26A, 26B. The loader mechanism 150 also includes a cooling fluid source 120. It should be understood that FIGS. 7A-7F are cross sections, and that the cooling fluid source 120 may be located inside of the loading mechanism 150. In some embodiments, if a sensor (such as the IR sensor or proximity sensor of FIG. 2) does not have verification that a movement or action did not occur, it will not proceed. In some embodiments, this is accomplished through the PLC, two proximity sensors (one at P1 and one at P3), an optical sensor, three microswitches, and four reed switches.

The process begins with all air cylinders (such as air cylinders 20, 21 of FIG. 3) in the retracted position, as shown in FIG. 7A. The loader mechanism 150 retracts to prepare for loading, the ram air cylinder retracts to the loading position P1. In some embodiments, the gate plate (as described in FIG. 4) is retracted to be in a loading slot which locks into the loading position P1 when the positioning air cylinder (positioning cylinder 20 of FIG. 3) extends later. With all air cylinders retracted, this assures a measure of safety when the unit is turned on next time. In some embodiments, this may avoid pinching a user's fingers before air pressure is applied.

A target housing 200 may be verified in position. In some embodiments, the target housing 200 may be any target housing illustrated or described herein, including the target housing of any of FIGS. 6A-6F. In some embodiments, the target housing 200 may be verified to be at the loading position P1 with a magazine proximity sensor (such as magazine proximity sensor 12). Once verified, the loader mechanism 150 can move forward to meet with the target 200, as shown in FIG. 7B. As the loader mechanism 150 makes contact with the target housing 200 the at least one jaw 26A, 26B begins to open. In some embodiments, the at least one jaw 26A, 26B have an angled inner surface. In such embodiments, when the at least one jaw 26A, 26B begins to open, the at least one jaw 26A, 26B slides on its angled inner surface against the back of the target housing 200. In some embodiments, the at least one jaw 26A, 26B slides into the target groove (such as groove G) and loosely lock the target housing 200 into place. This may be verified when one or more reed switches of the loader mechanism 150 closes.

Next the loader mechanism 150 may move towards the irradiation position P2. The loader mechanism 150 retracts to clear the magazine 11 verified by the one or more reed switches of the loader mechanism 150. The positioning air cylinder extends, moving the cooling cup 27 laterally to the irradiation position P2. In some embodiments, this may be verified by a microswitch closing. The loader mechanism 150 can then extend.

As shown in FIG. 7C, as the loader mechanism 150 extends, the target housing 200 is placed in a “ready to Irradiate state” (or irradiation position P2). As the target housing 200 nears the beamline endplate 1 it may self-level to the beamline endplate 1, in order to achieve parallelism and an O-ring vacuum seal of the sliding seal 28. In some embodiments, two different radii at a cooling cup 27 and target housing 200 interface allow this pivoting and self-leveling. The loader mechanism 150 then pushes farther on the target housing 200 moving the sliding seal 28 to the back of the target housing 200 as the sliding seal 28 compresses its O-ring. The position of the target housing 200 may be verified by the irradiate proximity sensor (such as irradiate proximity sensor 13 of FIG. 1). Verification allows vacuum to be pulled on the target housing 200 and the beamline 37, further increasing the seal of the target housing 200 groove. In some embodiments, a cooling fluid F is turned on to maximum flow. In some embodiments, the cooling fluid is dispensed from the cooling fluid source 120. In some embodiments, the cooling fluid is water. Once all positions are verified irradiation can begin which can be as short as 5 minutes or even many hours. In some embodiments, irradiation is provided with beam B.

The cooling fluid source 120 may utilize full house water pressure for maximum water flow at the cooling cup 27 to the water recess 250 behind the target 200. The pneumatic system may be throttled down from house air to approximately 100 PSI (pounds per square inch). Once passed through a manifold the air is divided into three systems, one for each of the three cylinders 20, 21. In some embodiments, each cylinder is independently controlled with both air pressure and air flow. In some embodiments, all three cylinders are double acting movements. Both the ram air cylinder 20 and positioning air cylinder 21 utilize flow controllers on both ports of the cylinder. This effectively controls extraneous acceleration of their rams. In some embodiments, the air valves (such as air valves and coils 19 in FIG. 1) are 5/2 varieties with 5 ports and two positions. In some embodiments, the air valves operate at 24 VAC (volts alternating current) and are an air pilot type where air pressure aids positioning, minimizing current draw of the coils.

Once irradiation is completed ejection can then occur, as shown in FIG. 7E. In some embodiments, the vacuum is turned off and then vented to atmospheric pressure. In some embodiments, the radioisotope target loader 100 is further configured to verify that this has occurred. The cooling water F may then be turned off. In some embodiments, a blast of air can be applied to clear out the water lines. The loader mechanism 150 retracts with the target housing 200 being pulled via the at least one jaw 26A, 26B, releasing any stuck O-rings of the sliding seal 28 in the process. Retraction is verified by the ram retract reed switch. The positioning ram may still be extended with air pressure. In some embodiments, only the positioning cylinder is extended to move the loader mechanism 150 to the Eject position. In some embodiments, the gate changes to the ejection position P3 slot. Movement may be verified by the actuation of an eject position microswitch closing.

In some embodiments, ejection of the target housing 200 is accomplished when the loader mechanism 150 extends. In some embodiments, the loader mechanism 150 moves the target housing 200 forward as one or more air cylinder is once again extended. As the target housing 200 makes contact with the ejector 15, the at least one jaw 26A, 26B begins to open releasing the target housing 200 from the loader mechanism 150. Depending on the weight and thickness of the target housing 200, it may drop as it approaches or may drop as the loader mechanism retracts. In some embodiments, the loader mechanism 150 supplies s burst of air to assist in ejection. The target housing 200 then falls into the ejection chute 15. In some embodiments, the ejection chute 15 is a tapered ejection chute. An IR sensor 16 then registers that the target has fallen. In some embodiments, the IR sensor 16 is located at the end of the taper of the ejection chute 15, as shown in FIG. 1. The target is then free to fall into a lead shipping pig, a lead transport cart, or a vacuum transport system.

Once the target falls and breaks the IR beam, the loader mechanism 150 is free to return to its safe position (i.e., retracted at the loading position P1). This begins with the loader mechanism 150 retracted and the gate plate (such as gate plate 23) retracted. In some embodiments, both are verified with retract reed switches closing. The positioning cylinder is then retracted. Since the gate plate is retracted, the ball bearing guide is free to move from the ejection to the irradiation slot, cross through the vertical channel, and then slide from the irradiation slot to the loading slot. These movements may be smooth with only a small click as the guide crosses the vertical channel.

In some embodiments, the loader mechanism 150 then returns to the loading position P1 with all cylinders retracted. In some embodiments, the process may be repeated for any number of additional target housings 200.

FIG. 8A is a top perspective view of an example device for manufacturing a target housing (also referred to herein as “the device”) 300, in accordance with the present technology. FIG. 8B is a bottom perspective view of the device for manufacturing a target housing 300 of FIG. 8A, in accordance with the present technology. In some embodiments, disclosed herein is a device for manufacturing a target housing 300 including a base 311 comprising a recess 304, a ball bearing 301 configured to rest in the recess 304, and a platform 302 configured to rest on top of the ball bearing 301. In some embodiments, the platform 302 includes a top face TF including a stepped surface 305 at the center of the platform 302 configured to hold a target housing (such as target housing 200 of FIGS. 6A-6F), at least one clamp 307 configured to form a groove on the target housing, and at least one screw 306A, 306B . . . 306N located midway between an edge E and the center of the platform 302 where the at least one screw 306A, 306B . . . 306N is configured to coarsely adjust the target housing. In some embodiments, the device 300 further includes at least one setscrew 313A, 313B, 313C configured to flex the platform 302 to finely adjust the target housing. While three setscrews 313A, 313B, 313C are illustrated, and number of setscrews may be used. In some embodiments, the platform 302 further includes a bottom face BF, including a cylindrical recess 310 configured to contain at least a portion of the ball bearing 301, and an inner portion 308 and an outer portion 309, delineated by a recessed circular groove CG, where the recessed circular groove CG is configured to flex the inner portion 308 separately from the outer portion 309.

In some embodiments, the device 300 can be configured to produce a target housing having a high precision thickness. High precision thickness may be desirable as it maximizes the production rate of the desired isotope, minimizes the production of waste isotopes, and optimizes the thermal properties of the target allowing increased incident beam current.

In some embodiments, the base 311 and adjustable platform 302 are made of 6061-T6 aluminum. In some embodiments, the base 311 is a plain (or unadorned) cylinder with a recess 304. In some embodiments, the recess 304 is configured to hold a single 20 mm ball bearing 301 at the recess's 304 center. In some embodiments, the adjustable platform 302 has a stepped surface 305 with a cylindrical recess in the center of the adjustable platform 302 on a back face BF. The front stepped surface 305 may be configured to register the target housing concentrically. In some embodiments, the device 300 may include one or more clamps 307. In some embodiments, there are six clamps 307 on the adjustable platform 302 that register the groove on an outside diameter of the target housing. The adjustable platform 302 may be roughly adjusted by any number of screws, such as three screws 306A, 306B . . . 306N situated midway radially from the center of the adjustable platform 302. This allows coarse adjustment to approximately 50 mm or less. In some embodiments, the device 300 includes one or more outer setscrews 313A, 313B, 313C. Adjustment via the ultra-fine threaded setscrews (0.2 mm pitch) 3134A, 314B . . . 314N around the adjustable platform 302 allows the adjustable platform 302 to flex similar to a teeter-totter or leverage wedge. The flexing is accomplished via the recessed circular groove CG on back face BF of the adjustable platform 302, which allows separate movement of the inner 308 and outer portions 309 of the adjustable platform 302. Conventionally, devices used to machine target housings try to prevent the flexing of various parts to assure rigidly held parts. In contrast, the device 300 makes use of any flexing to its advantage to allow very small finite adjustments.

Cutting forces may also be addressed. In some embodiments, lateral machining forces are absorbed by the large ball bearing 301. In some embodiments, the device 300 further includes a single locating pin 303 on the base 311 which fits well with a cutout 312 on the adjustable platform 302. The locating pin 303 absorbs the rotational cutting forces during machining. In some embodiments balancing forces are absorbed by the 6 adjustable screws, i.e., setscrews 306A, 306B . . . 306N and the outer setscrews 313A, 313B, 313C. In some embodiments, machining of these target housings generate relatively very little forces since the target housings are extremely thin. In some embodiments, a high-rake cutter (25° or more, up to 45°) is used for high purity materials.

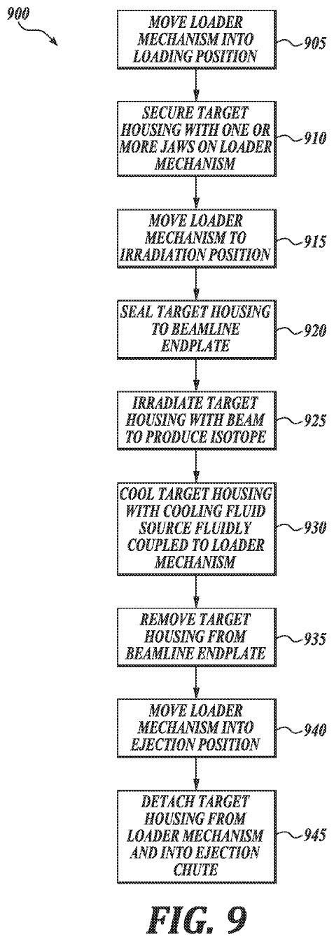

FIG. 9 is an example method 900 of using a radioisotope target station (such as radioisotope target station 100), in accordance with the present technology.

In block 905, the loader mechanism (such as loader mechanism 150) is moved into a loading position (such as loading position P1). In some embodiments, the loader mechanism is moved to the loading position with one or more air cylinders (such as air cylinders 20, 21). In some embodiments, the loader mechanism retracts a cooling cup (such as cooling cup 27) as the loader mechanism moves, to avoid damage the radioisotope target station, a user of the radioisotope target station, or both.

In block 910, a target housing (such as target housing 200) is secured with one or more jaws (such as jaws 26A, 26B) of the loader mechanism. In some embodiments, as the loader mechanism moves towards a magazine (such as magazine 11), the one or more jaws open to receive the target housing. In some embodiments, the magazine is configured to hold any number of targets. In some embodiments, magazine is loaded with one or more target housings, remote from the radioisotope target station, to reduce radiation exposure; and then the magazine is slid into the radioisotope target station.

In block 915, the loader mechanism is moves to an irradiation position (such as irradiation position P2). In some embodiments, the loader mechanism retracts before moving to the irradiation position. In some embodiments, the irradiation position includes a beamline (such as beamline 37), and a beam (such as beam B).

In block 920, the target housing is sealed to a beamline endplate (such as beamline endplate 1). In some embodiments, the target housing is sealed to the beamline. In some embodiments, the target housing is sealed with vacuum sealing. In some embodiments, the target housing is sealed with a groove on the first face of the target housing (such as groove G on the first face F1 of target housing 200 in FIGS. 6A-6F). In some embodiments, both vacuum sealing and groove (or O-ring) sealing may be applied concurrently or simultaneously.

In block 925, the target housing is irradiated with the beam to produce an isotope. In some embodiments, the isotope produced is selected from Sr⁸⁵, Sn^{117m}, Tb¹⁵⁵, Re¹⁸⁶, Re¹⁸⁹, At²¹¹, U²³⁰, Pa²³⁰, Np²³⁶, Ge⁶⁸, In¹¹¹, I¹²³, I¹²⁴, and Lu¹⁷⁷. In some embodiments, the target housing is irradiated orthogonally to the beam.

In block 930, the target housing is cooled with a cooling fluid (such as cooling fluid F) from a cooling fluid source (such as cooling fluid source 120) fluidly coupled to the loader mechanism.

In block 935, the target housing is removed from the beamline endplate. In some embodiments, before removing the target housing, a puff of air is applied to the target housing to remove the cooling fluid. In some embodiments, the target housing is removed with the one or more jaws after the vacuum sealing is stopped.

In block 940, the loader mechanism is moved to the ejection position (such as ejection position P3). In some embodiments, the ejection position includes an ejector (such as ejector 15) an ejection chute (such as ejection chute 15), and/or an ejection proximity sensor (such as ejection proximity sensor 16).

In block 945, the target housing is detached from the loader mechanism and dropped into the ejection chute. In some embodiments, the ejector is configured to remove the target housing from the one or more jaws. In some embodiments, the one or more jaws are configured to open to allow the target housing to be detached. In some embodiments, the ejection chute leads to a pig, a vacuum or pneumatic transport system, or a transport cart for further containment.

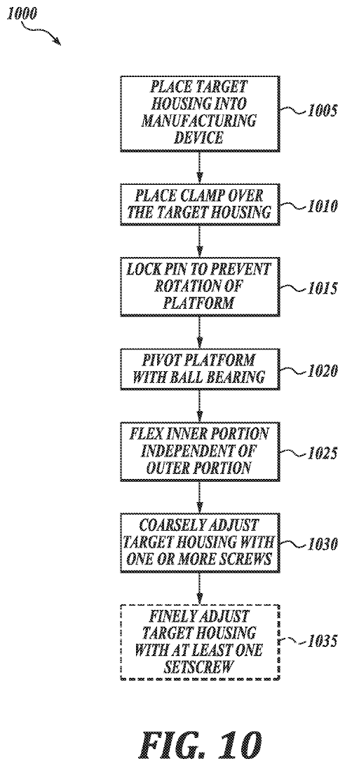

FIG. 10 is an example method 1000 of using a device for manufacturing a target housing (such as device 300), in accordance with the present technology.

In block 1005, a target housing (such as target housing 200) is placed inside the device. In some embodiments, the target is placed on a stepped surface (such as stepped surface 305) of an adjustable platform (such as adjustable platform 302).

In block 1010, at least one clamp (such as clamp 307) is placed over the target housing. In some embodiments, the at least one clamp is six clamps, arranged in a circular form. In some embodiments, the clamp prevents the target housing from rotating or moving about the adjustable platform.

In block 1015, a locking pin (such as locking pin 303) on a base (such as base 311) is locked to prevent the adjustable platform from rotating. In some embodiments, the locking pin is configured to slot into a cutout (such as cutout 312) on the adjustable platform.

In block 1020, the adjustable platform is pivoted with a ball bearing (such as ball bearing 301). In some embodiments, the ball bearing rests in a recess (such as recess 304) in the base and in a cylindrical recess (such as cylindrical recess 310) of the adjustable platform. In this manner, the adjustable platform may pivot.

In block 1025, an inner portion (such as inner portion 308) of the adjustable platform is flexed independently of an outer portion (such as outer portion 309). In this manner, the device may utilize the flexing motion of the inner portion to machine the target housing.

In block 1030, a thickness of the target housing may be coarsely adjusted with one or more setscrews (such as setscrews 306A, 306B . . . 306N).

Optionally, in block 1035, the thickness of the target housing may be finely adjusted with one or more screws (such as screws 308A, 308B . . . 308N).

It should be understood that all methods 900 and 1000 should be interpreted as merely representative. In some embodiments, process blocks of all methods 900 and 1000 may be performed simultaneously, sequentially, in a different order, or even omitted, without departing from the scope of this disclosure.

The present application may reference quantities and numbers. Unless specifically stated, such quantities and numbers are not to be considered restrictive, but representative of the possible quantities or numbers associated with the present application. Also, in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A, B, and C,” for example, means (A), (B), (C), (A and B), (A and C), (B and C), or (A, B, and C), including all further possible permutations when greater than three elements are listed.

Embodiments disclosed herein may utilize circuitry in order to implement technologies and methodologies described herein, operatively connect two or more components, generate information, determine operation conditions, control an appliance, device, or method, and/or the like. Circuitry of any type can be used. In an embodiment, circuitry includes, among other things, one or more computing devices such as a processor (e.g., a microprocessor), a central processing unit (CPU), a digital signal processor (DSP), an application-specific integrated circuit (ASIC), a field-programmable gate array (FPGA), or the like, or any combinations thereof, and can include discrete digital or analog circuit elements or electronics, or combinations thereof.

An embodiment includes one or more data stores that, for example, store instructions or data. Non-limiting examples of one or more data stores include volatile memory (e.g., Random Access memory (RAM), Dynamic Random Access memory (DRAM), or the like), non-volatile memory (e.g., Read-Only memory (ROM), Electrically Erasable Programmable Read-Only memory (EEPROM), Compact Disc Read-Only memory (CD-ROM), or the like), persistent memory, or the like. Further non-limiting examples of one or more data stores include Erasable Programmable Read-Only memory (EPROM), flash memory, or the like. The one or more data stores can be connected to, for example, one or more computing devices by one or more instructions, data, or power buses.

In an embodiment, circuitry includes a computer-readable media drive or memory slot configured to accept signal-bearing medium (e.g., computer-readable memory media, computer-readable recording media, or the like). In an embodiment, a program for causing a system to execute any of the disclosed methods can be stored on, for example, a computer-readable recording medium (CRMM), a signal-bearing medium, or the like. Non-limiting examples of signal-bearing media include a recordable type medium such as any form of flash memory, magnetic tape, floppy disk, a hard disk drive, a Compact Disc (CD), a Digital Video Disk (DVD), Blu-Ray Disc, a digital tape, a computer memory, or the like, as well as transmission type medium such as a digital and/or an analog communication medium (e.g., a fiber optic cable, a waveguide, a wired communications link, a wireless communication link (e.g., transmitter, receiver, transceiver, transmission logic, reception logic, etc.). Further non-limiting examples of signal-bearing media include, but are not limited to, DVD-ROM, DVD-RAM, DVD+RW, DVD-RW, DVD-R, DVD+R, CD-ROM, Super Audio CD, CD-R, CD+R, CD+RW, CD-RW, Video Compact Discs, Super Video Discs, flash memory, magnetic tape, magneto-optic disk, MINIDISC, non-volatile memory card, EEPROM, optical disk, optical storage, RAM, ROM, system memory, web server, or the like.

The detailed description set forth above in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result. Generally, the embodiments disclosed herein are non-limiting, and the inventors contemplate that other embodiments within the scope of this disclosure may include structures and functionalities from more than one specific embodiment shown in the figures and described in the specification.

In the foregoing description, specific details are set forth to provide a thorough understanding of exemplary embodiments of the present disclosure. It will be apparent to one skilled in the art, however, that the embodiments disclosed herein may be practiced without embodying all the specific details. In some instances, well-known process steps have not been described in detail in order not to unnecessarily obscure various aspects of the present disclosure. Further, it will be appreciated that embodiments of the present disclosure may employ any combination of features described herein.

The present application may include references to directions, such as “vertical,” “horizontal,” “front,” “rear,” “left,” “right,” “top,” and “bottom,” etc. These references, and other similar references in the present application, are intended to assist in helping describe and understand the particular embodiment (such as when the embodiment is positioned for use) and are not intended to limit the present disclosure to these directions or locations.

The present application may also reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc. The term “about,” “approximately,” etc., means plus or minus 5% of the stated value. The term “based upon” means “based at least partially upon.”

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

1. A radioisotope target station, comprising:
a target housing including a target material and a target backing material;
a loader mechanism comprising at least one jaw configured to secure the target housing;
a loading position comprising a magazine, wherein the magazine is configured to hold two or more target housings;
an irradiation position comprising a beam, wherein the beam is configured to irradiate the target housing orthogonally;
a cooling fluid source fluidly coupled to the loader mechanism, wherein the cooling fluid source is configured to cool the target housing as the target housing is irradiated; and
an ejection position comprising an ejector and an ejection chute, wherein the ejector is configured to detach the target housing from the loader mechanism and the ejection chute is configured to receive the target housing when detached;
wherein the loader mechanism is configured to move between the loading position, the irradiation position, and the ejection position.

2. The radioisotope target station of claim 1, wherein the target housing further comprises an entrance window configured to retain the target material, wherein the entrance window is selected from graphite, graphene, silicon, aluminum, gold, and silver.

3-4. (canceled)

5. The radioisotope target station of claim 1, wherein the target housing is selected from aluminum, copper, gold, silver, platinum, and combinations thereof.

6. The radioisotope target station of claim 1, wherein the target backing material further comprises a thin layer selected from copper, silver, gold, platinum, graphite, graphene, and combinations thereof.

7. A method of producing an isotope with the radioisotope target station of claim 1, the method comprising:
moving the loader mechanism to the loading position;
securing the target housing with the one or more jaws on the loader mechanism, wherein the target comprises the target backing material and the target material;
moving the loader mechanism to the irradiation position;
sealing the target housing to the beamline endplate;
irradiating the target housing with the beam to produce an isotope, wherein the beam is orthogonal to the target housing;
cooling the target housing with the cooling fluid source fluidly coupled to the loader mechanism while the target housing is irradiated;
removing the target housing from the beamline endplate;
moving the loader mechanism to the ejection position; and
detaching the target housing from the loader mechanism and into the ejection chute.

8. The method of claim 7, wherein the method further comprises:
routing a cooling fluid to the target housing; and
removing the cooling fluid from the target housing after irradiation is complete.

9. The method of claim 7, wherein the isotope produced is selected from Sr⁸⁵, Sn^{117m}, Tb¹⁵⁵, Re¹⁸⁶, Re¹⁸⁹, At²¹¹, U²³⁰, Pa²³⁰, Np²³⁶, Ge⁶⁸, In¹¹¹, I¹²³, I¹²⁴, and Lu¹⁷⁷.

10. (canceled)

11. The method of claim 7, wherein the method further comprises receiving a target housing from a magazine at the loading position.

12. The method of claim 11, wherein the method further comprises:
loading the magazine with one or more target housings, remote from the radioisotope target station; and
sliding the magazine into the radioisotope target station.

13. The method of claim 7, wherein the method further comprises capturing the target housing in a pig after it is detached.

14. The method of claim 7, wherein the method further comprises capturing the target housing in a vacuum or pneumatic transport system after it is detached.

15. (canceled)

16. A target housing comprising:
a first face comprising:
a well configured to hold a target backing material and a target material orthogonally to a beam, and
a groove configured to vacuum seal the first face to a beamline endplate,
a second face, opposite the first face, comprising a water recess configured to fluidly couple with a cooling fluid source, and
a thickness between the first and second face, wherein the thickness ranges from 6-20 mm thick.

17. The target housing of claim 16, wherein the target housing further comprises a top portion comprised of graphite, graphene, silicone, gold, or platinum, wherein the top portion is configured to connect to the first face and secure the target material.

18. The target housing of claim 17, wherein the top portion comprises an opening configured to expose the target material.

19. The target housing of claim 17, wherein the target housing is selected from aluminum, copper, gold, silver, platinum, and a combination thereof.

20. The target housing of claim 17, wherein the target material is selected from bismuth, tungsten, tungsten disulfide, rubidium chloride, cadmium, thorium, germanium, uranium, europium oxide, gadolinium oxide, silver, zinc, Ytterbium, osmium, cobalt, nickel, and antimony.

17. The target housing of claim 17, wherein the target backing material is selected from copper, silver, gold, platinum, graphite, graphene and a combination thereof.

22. The target housing of claim 17, wherein the top portion further comprises an entrance window selected from graphite, graphene, silicon, aluminum, gold, and silver.

23. A device for manufacturing a target housing, comprising:
a base comprising a recess;
a ball bearing configured to rest in the recess; and
a platform configured to rest on top of the ball bearing, the platform comprising:
a top face, comprising:
a stepped surface at the center of the platform configured to hold a target housing,
at least one clamp configured to form a groove on the target housing,
at least one screw located midway between an edge and the center of the platform and configured to coarsely adjust the target housing,
at least one setscrew configured to flex the platform to finely adjust the target housing, and
a bottom face, comprising:
a cylindrical recess configured to contain a portion of the ball bearing, and
an inner portion and an outer portion, delineated by a recessed circular groove, wherein the recessed circular groove is configured to flex the inner portion separately from the outer portion.

23. The device of claim 23, wherein the device further comprises a locating pin on the base configured to prevent the platform from rotating.
